(19) United States
(12) Patent Application Publication
(10) Pub. No.: US 2018/0084589 A1
(43) Pub. Date: Mar. 22, 2018

(54) WIRELESS DATA SHARING METHOD AND SYSTEM

(71) Applicant: PBC IP PTY LTD., Forestdale (AU)

(72) Inventor: Ross McKinnon, Brisbane (AU)

(73) Assignee: PBC IP PTY LTD., Forestdale (AU)

(21) Appl. No.: 15/554,696

(22) PCT Filed: Mar. 4, 2016
(86) PCT No.: PCT/AU2016/050149

§ 371 Date: Aug. 30, 2017

(30) Foreign Application Priority Data
Mar. 5, 2015 (AU) 2015900781

(51) Int. Cl. H04W 76/02

(52) U.S. Cl. CPC H04W 76/02; H04W 88/04

(57) ABSTRACT

A method and system for wireless data sharing enables wireless data to be shared efficiently between unfamiliar electronic devices. The method includes broadcasting identification data and supplementary data from a first electronic device using a first wireless technology; receiving on a second electronic device the identification data and supplementary data; initiating on the second electronic device an application associated with the identification data; matching the supplementary data to predetermined data using the application on the second electronic device; initiating, using the application on the second electronic device, a wireless data connection between the first electronic device and the second electronic device based on the match between the supplementary data and the predetermined data; and sharing data between the first electronic device and the second electronic device, using the wireless data connection.

### FIELD OF THE INVENTION

This invention relates generally to a method and system of wireless data sharing between electronic devices. In particular, although not exclusively, the invention relates to a method and system of wireless data sharing between mobile devices.

### BACKGROUND TO THE INVENTION

Data is ubiquitous, however, sharing data between unfamiliar electronic devices can be difficult. Another problem is that access to data can be expensive, especially on mobile devices. For example, internet connection on a mobile device via a GSM, 3g or 4g network is typically quite expensive, normally requiring a contract with a service provider which provides internet connection, telephone connection and SMS.

Some service providers offer tiered contracts, having a certain allowance for internet connection, telephone calls and SMS. A problem with these tiered contracts is that a user is typically charged extra costs at a higher rate if they exceed the allowance, and if a user does not use up their entire allowance any remaining balance is typically forfeited at the end of the billing period.

There is therefore a need for an improved method and system for wireless data sharing.

The reference to any prior art in this specification is not, and should not be taken as, an acknowledgement or any form of suggestion that the prior art forms part of the common general knowledge.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a method of wireless data sharing between a first electronic device and a second electronic device, including:

broadcasting identification data and supplementary data from the first electronic device using a first wireless technology;

receiving on the second electronic device the identification data and supplementary data;

initiating on the second electronic device an application associated with the identification data;

matching the supplementary data to predetermined data using the application on the second electronic device;

initiating, using the application on the second electronic device, a wireless data connection between the first electronic device and the second electronic device based on the match between the supplementary data and the predetermined data; and

sharing data between the first electronic device and the second electronic device, using the wireless data connection.

Preferably, the first wireless technology is a low energy wireless technology. More preferably, the first wireless technology is Bluetooth low energy wireless technology (also known as Bluetooth Smart technology). Suitably, the first wireless technology is capable of a peer-to-peer connection between the first electronic device and the second electronic device.

Preferably, the first electronic device is a first mobile electronic device, for example a smartphone. Preferably, the second electronic device is a second mobile electronic device, for example a smartphone. Alternatively, the first electronic device and/or the second electronic device may be a desktop or laptop computer.

Preferably, the step of broadcasting identification data and supplementary data from the first electronic device using a first wireless technology includes initiating an application on the first electronic device, the application on the first electronic device initiating the broadcasting of the identification data and supplementary data.

Preferably, when the second electronic device receives the identification data and supplementary data, the second electronic device compares the identification data to data relating to the application on the second electronic device. If there is a match, the step of initiating on the second electronic device an application associated with the identification data is performed.

Preferably, the method includes determining at the second electronic device the signal strength of a signal that encodes the broadcast identification data and supplementary data. Suitably if the signal strength is above a predetermined limit, the remaining steps of the method are performed.

Preferably, the method includes sending from the second electronic device to the first electronic device information relating to the data to be shared between the first electronic device and the second electronic device. For example, the second electronic device may send information relating to a cost for sharing data, such as a cost per megabyte, cost per minute or cost per message sent. Preferably the first electronic device sends a confirmation to the second electronic device. For example, the application on the first electronic device may automatically accept the cost for sharing data. Alternatively, a user using the first electronic device may be prompted to accept the cost for sharing data and once the user accepts the cost for sharing data, the first electronic device sends a confirmation to the second electronic device. Preferably the information relating to the data to be shared is sent using the first wireless technology. Preferably the confirmation is sent using the first wireless technology.

Preferably, the supplementary data relates to the type(s) of data that is to be shared. For example, the supplementary data may indicate that the first electronic device wishes to share an internet connection, telephone connection for voice calls and/or a telephone connection for SMS/MMS messages. Suitably the predetermined data relates to the type(s) of data that the second electronic device is able to share. For example, the predetermined data may indicate that the second electronic device is able to share an internet connection, telephone connection for voice calls and a telephone connection for SMS/MMS messages, alternatively, the predetermined data may indicate that the second electronic device is only able to share an internet connection.

In one aspect, the step of sharing data between the first electronic device and the second electronic device may involve sharing an internet connection of the second electronic device with the first electronic device. In this aspect, the supplementary data preferably indicates that the first electronic device wishes to share an internet connection of the second electronic device. Suitably the predetermined data indicates that the second electronic device is able to share an internet connection.

Preferably, the second electronic device initiates, using the application on the second electronic device, the wireless data connection between the first electronic device and the second electronic device using a second wireless technology. Preferably, the second wireless technology is capable of a data rate of more than 1 Mbit/s. Preferably, the second wireless technology is suitable for high bandwidth data. Suitably, the second wireless technology is capable of a peer-to-peer connection between the first electronic device and the second electronic device. Alternatively, the second wireless technology may operate in an infrastructure mode, requiring the first electronic device and the second electronic device to connect to an access point. Preferably, the second wireless technology is Wi-Fi technology. More preferably, the second wireless technology is Wi-Fi Direct technology. Alternatively, the second wireless technology may be Bluetooth Classic technology which, unlike Bluetooth low energy technology, is suitable for high bandwidth data.

Preferably, the step of initiating, using the application on the second electronic device, a wireless data connection between the first electronic device and the second electronic device based on the match between the supplementary data and the predetermined data further includes sending, using the first wireless technology, from the second electronic device to the first electronic device information relating to the data connection that is to be initiated. For example, the second electronic device may send to the first electronic device information required to establish the data connection, where the data connection uses the second wireless technology.

Preferably, the application on the second electronic device creates a sandbox environment through which the data to be shared is routed; in this manner, the user of the first electronic device is unable to access the second electronic device beyond the sandbox environment. Preferably, the application on the first electronic device creates a sandbox environment such that the user of the second electronic device is unable to access the first electronic device beyond the sandbox environment. Suitably, for an internet connection, telephone connection for voice calls or a telephone connection for SMS/MMS messages, the data to be shared is routed between the second electronic device's internet connection, telephone connection for voice calls or telephone connection for SMS/MMS messages and the sandbox environment. Preferably encrypted tunneling is used for the shared data such that the user of the second electronic device is unable to access the shared data. Suitably, for an internet connection, the shared data is routed between the second electronic device and a third party virtual private network provider, and between the third party virtual private network provider and the internet to increase privacy and security.

In another aspect, the step of sharing data between the first electronic device and the second electronic device involves sharing a telephone connection of the second electronic device with the first electronic device. In this aspect, the application on the second electronic device may turn off caller identification such that a call initiated by the first electronic device (via the second electronic device) does not use the caller identification of the second electronic device. Alternatively, the application on the second electronic device may change the caller id information. For example, the application on the second electronic device may change the caller id information to that of the first electronic device.

Preferably, the application on the second electronic device sends a disconnection warning signal to the first electronic device prior to the wireless data connection between the first electronic device and the second electronic device being disconnected. For example, if the user of the second electronic device needs to make a telephone call, or if the first electronic device and the second electronic device are about to move out of range.

In a further aspect, the step of sharing data between the first electronic device and the second electronic device may involve sharing a telephone connection of the second electronic device with the first electronic device to facilitate the sending of SMS and/or MMS messages. In this aspect, the application on the second electronic device may change the SMS and/or MMS address information such that any SMS and/or MMS sent by the first electronic device (via the second electronic device) does not use the SMS and/or MMS address information of the second electronic device.

Suitably, if the first electronic device sends an SMS (via the second electronic device), the data connection between the first electronic device and the second electronic device uses the first wireless technology.

In yet a further aspect, the step of sharing data between the first electronic device and the second electronic device may involve sharing data that is stored on the second electronic device. For example, data relating to attributes of a user to whom the second electronic device belongs. Preferably, the step of sharing data between the first electronic device and the second electronic device includes sharing data that is stored on the first electronic device. For example, data relating to attributes of a user to whom the first electronic device belongs.

Preferably, the step of sharing data between the first electronic device and the second electronic device includes sharing the location data of the second electronic device with the first electronic device. Preferably, the step of sharing data between the first electronic device and the second electronic device includes sharing the location data of the first electronic device with the second electronic device.

Preferably the method further includes logging the amount of data shared and sending this information to a remote server. Suitably, an account associated with the first electronic device is debited an amount depending on the amount of data shared, and an account associated with the second electronic device is credited an amount depending on the amount of data shared.

In another form the invention resides in a system for wireless data sharing between a first electronic device and a second electronic device, the system including the second electronic device having a processor coupled to a memory, the memory including program code instructions configured to cause the processor of the second electronic device to:

receive identification data and supplementary data broadcast by the first electronic device using a first wireless technology;

initiate an application on the second electronic device associated with the identification data;

match the supplementary data to predetermined data;

initiate a wireless data connection between the first electronic device and the second electronic device based on the match between the supplementary data and the predetermined data; and

share data between the first electronic device and the second electronic device.

Preferably the system includes the first electronic device having a processor coupled to a memory, the memory including program code instructions configured to cause the processor of the first electronic device to broadcast the identification data and supplementary data using the first wireless technology.

Preferably, the first wireless technology is a low energy wireless technology capable of a peer-to-peer connection between the first electronic device and the second electronic device.

In another form the invention resides in a second electronic device for wireless data sharing between a first electronic device and the second electronic device, the second electronic device including a processor coupled to a memory, the memory including program code instructions configured to cause the processor to:

receive identification data and supplementary data broadcast by the first electronic device using a first wireless technology;

initiate an application on the second electronic device associated with the identification data;

match the supplementary data to predetermined data;

initiate a wireless data connection between the first electronic device and the second electronic device based on the match between the supplementary data and the predetermined data; and

share data between the first electronic device and the second electronic device.

Preferably, the memory of the second electronic device includes program code instructions configured to cause the processor to broadcast identification data and supplementary data associated with the second electronic device.

Further forms and/or aspects of the present invention will become apparent from the following detailed description.

### BRIEF DESCRIPTION OF THE DRAWINGS

An embodiment of the invention will be described with reference to the accompanying drawings in which:

FIG. 1 illustrates a flow chart of a method of wireless data sharing according to an embodiment of the present invention;

FIG. 2 illustrates a flow chart of a method of wireless data sharing according to another embodiment of the present invention;

FIG. 3 illustrates a system according to an embodiment of the present invention;

FIG. 4 illustrates a system according to a second embodiment of the present invention;

FIG. 5 illustrates a system according to a third embodiment of the present invention;

FIG. 6 illustrates a system according to a fourth embodiment of the present invention;

FIG. 7 illustrates a system according to a fifth embodiment of the present invention; and

FIG. 8 diagrammatically illustrates an electronic device for performing the method of the present invention according to an embodiment of the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

Embodiments of the present invention enable wireless data to be shared between unfamiliar electronic devices. For example, in some embodiments of the present invention a first electronic device can share data via a second electronic device's internet connection, telephone connection for voice calls and/or telephone connection for SMS/MMS messages. An advantage of this is that the first electronic device does not have to have an internet/telecommunications service provider. Another advantage is that if the first electronic device has used up its data allowance for internet, voice calls and/or SMS/MMS for a current billing period, it can send and receive data using a second electronic device as a proxy, instead of being charged extra costs at a higher rate from its own internet/telecommunications provider. Thus subscribers to data services can effectively sell or otherwise provide their unused data allowances from a given billing cycle to third parties. A further advantage is that if the first electronic device is outside of a service area of its own internet/telecommunications provider, it can share data via a second electronic device's internet/telecommunications provider. Yet a further advantage of some embodiments of the present invention is that discovery of the first electronic device is achieved using signals sent using a low energy wireless technology to conserve power, and data is then shared using signals sent using a wireless technology suitable for high bandwidth data. Still other advantages of various embodiments of the present invention include improved data sharing applications based on proximity or other attributes that are in common between users of electronic devices.

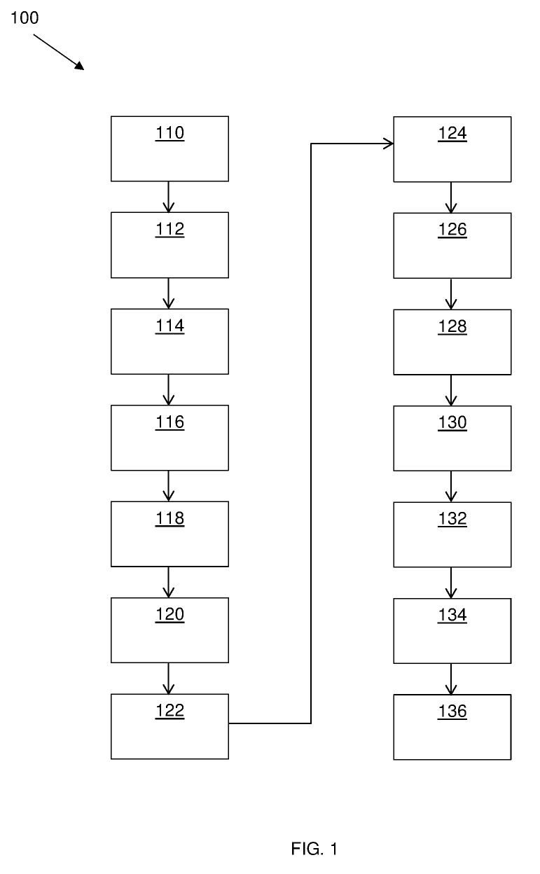

FIG. 1 illustrates a flow chart of a method of wireless data sharing 100 according to an embodiment of the present invention.

At step 110 an application is initiated on a first electronic device. In one embodiment, a user using the first electronic device initiates the application on the first electronic device if they wish to share data. As an example the user of the first electronic device may not have a service provider or may have used up their entire allowance for internet access for the current billing period and wishes to share an Internet connection (i.e. share data via another electronic device's Internet connection).

At step 112, the application broadcasts identification data and supplementary data from the first electronic device using a first wireless technology. The first wireless technology is a low energy wireless technology. In a preferred embodiment, the first wireless technology is Bluetooth low energy wireless technology also known as Bluetooth Smart technology. Low energy wireless technology and Bluetooth low energy wireless technology are well known in the art and will not be explained here in detail. A benefit of using a low energy wireless technology is that such a low energy wireless technology transmits small packets of data and is power efficient. The identification data is associated with the application. For example, a portion of the identification data identifies the application. In a preferred embodiment, the identification data is a universally unique identifier (UUID). The supplementary data includes data relating to the type of data that the first electronic device wishes to share. For example, the supplementary data includes data that indicates that the first electronic device wishes to share an internet connection.

At step 114, a second electronic device receives the identification data and the supplementary data.

At step 116, the second electronic device initiates an application associated with the identification data. In one embodiment, the second electronic device compares the identification data to a table of one or more applications to determine if an attribute of one of the one or more applications matches the identification data. If there is a match, the second electronic device initiates the corresponding application.

At step 118, the second electronic device determines the signal strength of a signal that encodes the broadcast identification data and supplementary data. If the signal strength is above a predetermined limit the method continues. A benefit of this is that potentially low quality wireless connections between the first electronic device and the second electronic device can be avoided. A person skilled in the art will understand that this step could also be carried out prior to step 116.

At step 120 the application on the second electronic device matches the supplementary data to predetermined data to determine if a wireless data connection between the first electronic device and the second electronic device is to be made. For example, the predetermined data can indicate that the second electronic device can share an internet connection. If, for example the predetermined data indicated that the second electronic device cannot share an internet connection and the first electronic device wishes to share an internet connection, the second electronic device would not continue with the method.

At step 122, if there is a match at step 120 between the supplementary data and the predetermined data, the second electronic device sends information relating to the data to be shared. For example, the second electronic device sends cost information to the first electronic device relating to the cost of sharing an internet connection. This information relating to the data to be shared is sent by the second electronic device using the first wireless technology.

At step 124 the first electronic device receives the information relating to the data to be shared.

At step 126 the first electronic device sends a confirmation to the second electronic device. For example, the application on the first electronic device automatically accepts the cost of sharing an internet connection if the cost is below a predetermined value and sends a confirmation to the second electronic device. In another embodiment, the user using the first electronic device is prompted to accept the cost for sharing data and once the user accepts the cost for sharing data, the first electronic device sends a confirmation to the second electronic device. The confirmation is sent from the first electronic device to the second electronic device using the first wireless technology.

At step 128, the second electronic device receives the confirmation from the first electronic device.

At step 130, the second electronic device determines the type of wireless data connection that is required and sends wireless data connection information such that a wireless data connection using a second wireless technology can be established between the first electronic device and the second electronic device. The wireless data connection information is sent from the second electronic device to the first electronic device using the first wireless technology. The second wireless technology is suitable for high bandwidth data. In a preferred embodiment, the second wireless technology is a Wi-Fi technology such as Wi-Fi Direct technology. Wi-Fi technology and Wi-Fi Direct technology are well known in the art and will not be explained here in detail.

At step 132 a wireless data connection is established between the first electronic device and the second electronic device using the second wireless technology.

At step 134, data is shared between the first electronic device and the second electronic device using the second wireless technology.

At step 136, once the data has been shared between the first electronic device and the second electronic device, the second electronic device sends to a server information relating to an amount of data that was shared between the first electronic device and the second electronic device. Using this information, the server debits an amount depending on the amount of data shared from an account associated with the first electronic device, and credits an account associated with the second electronic device an amount depending on the amount of data shared.

A person skilled in the art will understand that steps 122-128 and 136 may be omitted, for example when data is shared for free, or when the second electronic device does not share an internet connection or a telephone connection.

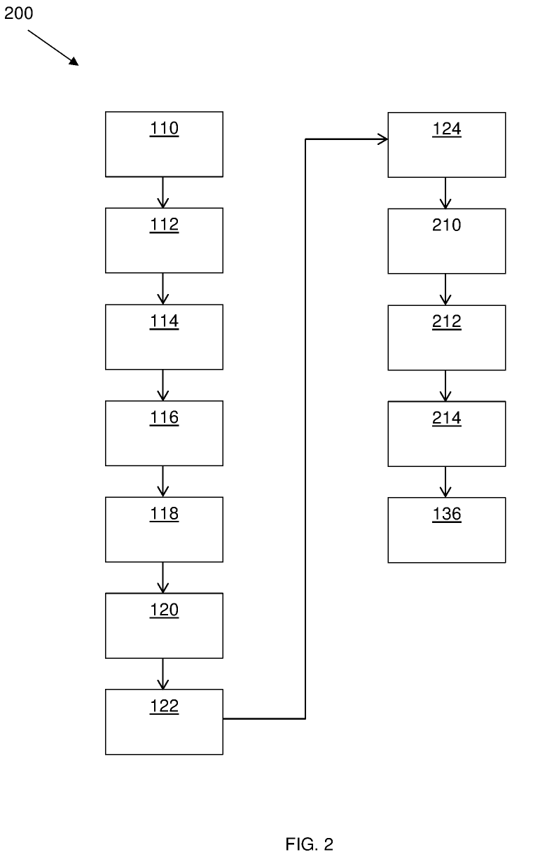

FIG. 2 illustrates a flow chart of a method of wireless data sharing 200 according to another embodiment of the present invention where a first electronic device wishes to share a limited amount of data. For example, the first electronic device wishes to send an SMS (i.e. share data via another electronic device's telephone connection for SMS messages).

Steps 110-124 are the same as described with reference to FIG. 1. It will be appreciated that in the embodiment shown in FIG. 2, a wireless data connection is initiated by the second electronic device at step 122 when the second electronic device sends information relating to the data to be shared.

At step 210, the first electronic device sends a confirmation to the second electronic device and data that is to be shared. For example, the application on the first electronic device automatically accepts the cost of sending an SMS if the cost is below a predetermined value and sends a confirmation as well as the data that is to be shared (data for the SMS to be sent) to the second electronic device. In another embodiment, the user using the first electronic device is prompted to accept the cost for sharing data and once the user accepts the cost for sharing data, the first electronic device sends a confirmation as well as the data that is to be shared to the second electronic device. The confirmation and the data that is to be shared is sent from the first electronic device to the second electronic device using the first wireless technology.

At step 214, the second electronic device sends a confirmation to the first electronic device that the data has been shared. For example, the second electronic device sends a confirmation to the first electronic device that the SMS message has been sent.

Step 136 is the same as described with reference to FIG. 1.

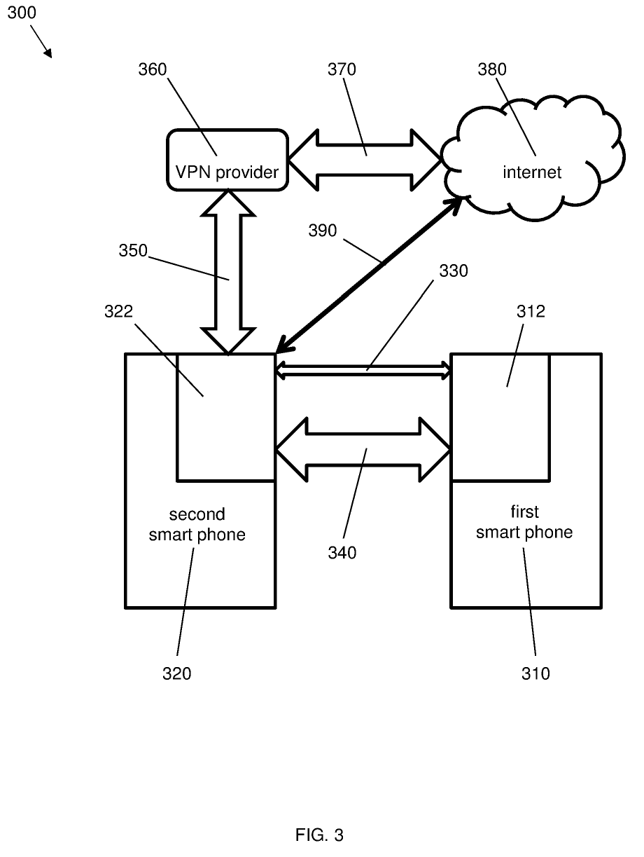

FIG. 3 illustrates a system 300 according to an embodiment of the present invention. In one embodiment, the method 100 of FIG. 1 is performed on the system 300. The system 300 has a first electronic device in the form of a first smart phone 310 and a second electronic device in the form of a second smart phone 320. In this embodiment, the first smart phone 310 wishes to share a connection to the internet 380 (i.e. share data via another electronic device's internet connection).

An application (not shown) is initialised on the first smart phone 310. The application creates a sandbox environment 312 on the first smart phone 310 such that when connected to the second smart phone 320, the second smart phone 320 is unable to access the first smart phone 310 beyond the sandbox environment 312. A sandbox environment is a well known security mechanism in the art and will not be explained here in detail.

The application on the first smart phone 310 causes the first smart phone 310 to broadcast identification data and supplementary data using a first wireless technology in the form of Bluetooth low energy wireless technology signals 330. In one embodiment, the identification data is in the form of a universally unique identifier (UUID) and the supplementary data is in the form of a major and minor pair. The use of UUID and a major and minor pair with Bluetooth low energy wireless technology is well known in the art and will not be explained here in detail.

The second smart phone 320 receives the identification data and supplementary data broadcast using the Bluetooth low energy wireless technology signals 330. The second smart phone 320 initiates an application associated with the identification data. The application on the second smart phone 320 creates a sandbox environment 322 such that when connected to the first smart phone 310, the first smart phone 310 is unable to access the second smart phone 320 beyond the sandbox environment 322.

The application on the second smart phone 320 compares the supplementary data to predetermined data and establishes that the first smart phone 310 wishes to share an internet connection and that the second smart phone 320 is able to share an internet connection. After sending information relating to the cost for sharing data and receiving a confirmation from the first smart phone 310 using the Bluetooth low energy wireless technology signals 330, the second smart phone 320 sends wireless data connection information to the first smart phone 310 using the Bluetooth low energy wireless technology signals 330. The second smart phone 320 then initiates a wireless data connection to the first smart phone 310 using a second wireless technology in the form of Wi-Fi Direct technology signals 340.

The application on the second smart phone 320 establishes a secure tunnel 350 to a third party virtual private network (VPN) provider 360, which provides an access connection 370 to the internet 380 to increase the privacy and security of the shared data. As can be seen from FIG. 3, the data to be shared is routed between the first smart phone 310 and the internet 380 via the wireless data connection using the Wi-Fi direct technology signals 340, through the sandbox environment 322 on the second smart phone 320, the secure tunnel 350 to the third party VPN provider 360 and from the third party VPN provider 360 to the internet 380 via the access connection 370.

The second smart phone 320 logs the amount of data that is shared with the first smart phone 310. Once the data sharing between the first smart phone 310 and the second smart phone 320 is finished, the second smart phone 320 sends and receives information relating to the amount of data shared, to and from a server (not shown) via a connection 390 to the internet 380. The second smart phone 320 also sends information relating to the amount of data shared to the first smart phone 310 using the Bluetooth low energy wireless technology signals 330. In an alternate embodiment, the second smart phone 320 sends information relating to the amount of data shared to the first smart phone 310 using the Wi-Fi Direct technology signals 340.

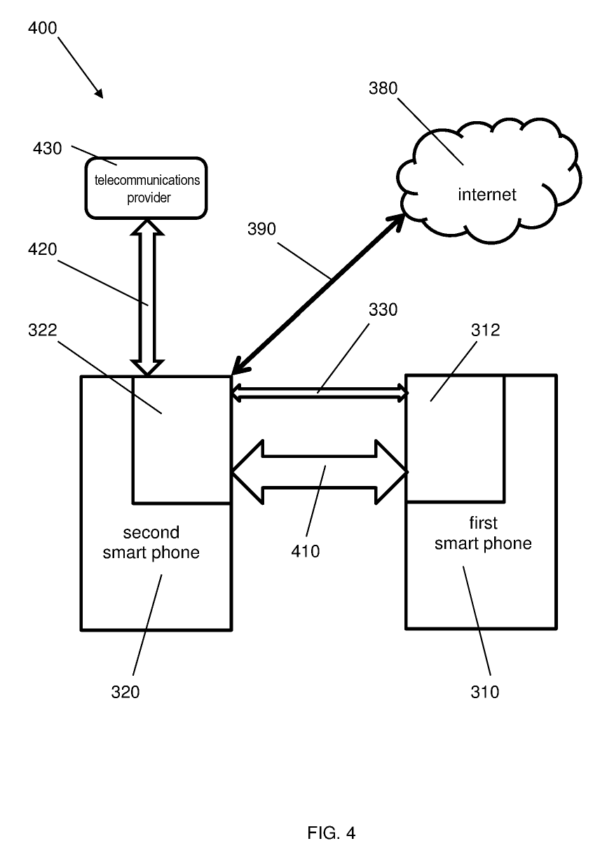

With reference to FIG. 4, there is illustrated a system 400 according to an embodiment of the present invention. In one embodiment, the method 100 of FIG. 1 is performed on the system 400. The system 400 has a first electronic device in the form of a first smart phone 310 and a second electronic device in the form of a second smart phone 320. In this embodiment, the first smart phone 310 wishes to share a telephone connection 420 (i.e. share data via another electronic device's telephone connection).

In a similar manner to the system 300 described with reference to FIG. 3, in the system 400, the first smart phone 310 broadcasts identification data and supplementary data using Bluetooth low energy wireless technology signals 330. The second smart phone 320 receives the identification data and supplementary data and compares the supplementary data to predetermined data and establishes that the first smart phone 310 wishes to share a telephone connection and that the second smart phone 320 is able to share a telephone connection. After sending information relating to the cost for sharing data and receiving a confirmation from the first smart phone 310 using the Bluetooth low energy wireless technology signals 330, the second smart phone 320 sends wireless data connection information to the first smart phone 310 using the Bluetooth low energy wireless technology signals 330. The second smart phone 320 then initiates a wireless data connection to the first smart phone 310 using a second wireless technology in the form of Bluetooth Classic technology signals 410, which is suitable for high bandwidth data required for voice data. In an alternate embodiment (not shown) the second wireless technology is in the form of Wi-Fi Direct technology signals 340 as shown in FIG. 3.

The data to be shared is routed between the first smart phone 310 and a telecommunications provider 430 via the wireless data connection using Bluetooth Classic technology signals 420, the sandbox environment 322 and the telephone connection 420.

The application on the second smart phone 320 turns off caller identification of the second smart phone 320 such that a call initiated by the first smart phone 310 does not use the caller identification of the second smart phone 320. In an alternate embodiment (not shown) the application on the second smart phone 320 changes the caller id information to that of the first smart phone 310 whilst data is being shared (e.g. during a call initiated by the first smart phone 310).

In a similar manner as described with reference to FIG. 3, the second smart phone 320 sends and receives information relating to the amount of data shared, to and from a server (not shown) via a connection 390 to the internet 380 for billing purposes. The second smart phone 320 also sends information relating to the amount of data shared to the first smart phone 310 using the Bluetooth low energy wireless technology signals 330. In an alternate embodiment, the second smart phone 320 sends information relating to the amount of data shared to the first smart phone 310 using the Bluetooth Classic technology signals 410.

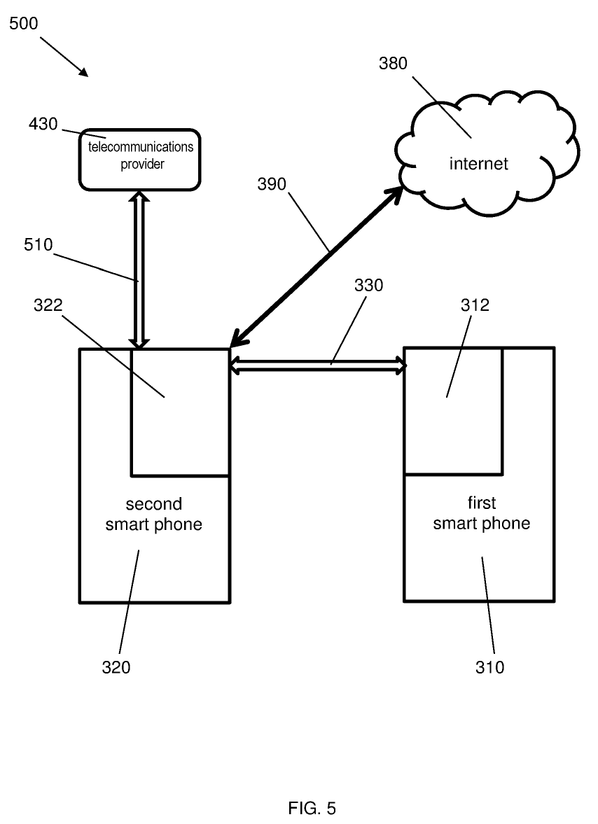

With reference to FIG. 5, there is illustrated a system 500 according to an embodiment of the present invention. In one embodiment, the method 200 of FIG. 2 is performed on the system 500. The system 500 has a first electronic device in the form of a first smart phone 310 and a second electronic device in the form of a second smart phone 320. In this embodiment, the first smart phone 310 wishes to send an SMS message via a telephone connection for SMS messages 510 (i.e. share data via another electronic device's telephone connection for SMS messages).

In a similar manner to the system 300 described with reference to FIG. 3, in the system 500, the first smart phone 310 broadcasts identification data and supplementary data using Bluetooth low energy wireless technology signals 330. The second smart phone 320 receives the identification data and supplementary data and compares the supplementary data to predetermined data and establishes that the first smart phone 310 wishes to share a telephone connection for SMS messages and that the second smart phone 320 is able to share a telephone connection for SMS messages.

The second smart phone 320 initiates a wireless data connection to the first smart phone 310 using the Bluetooth low energy wireless technology signals 330. The second smart phone 320 then sends information relating to the cost for sending SMS messages, using the Bluetooth low energy wireless technology signals 330. After receiving information relating to the cost for sending SMS messages from the second smart phone 320, the first smart phone 310 sends a confirmation and the data to be shared (i.e. data relating to the SMS message to be sent).

Once the second smart phone 320 receives the confirmation and the data to be shared, the application on the second smart phone 320 causes the second smart phone 320 to send the data to be shared as an SMS message via the telephone connection for SMS messages 510 to the telecommunications provider 430. In a preferred embodiment, the application on the second smart phone 320 changes the SMS address information such that any SMS sent by the first smart phone 310 (via the second smart phone 320) does not use the SMS address information of the second smart phone 320, and instead uses address information associated with the first smart phone 310.

In a similar manner as described with reference to FIG. 3, the second smart phone 320 sends and receives information relating to the amount of data shared, to and from a server (not shown) via a connection 390 to the internet 380 for billing purposes. The second smart phone 320 also sends information relating to the amount of data shared to the first smart phone 310 using the Bluetooth low energy wireless technology signals 330.

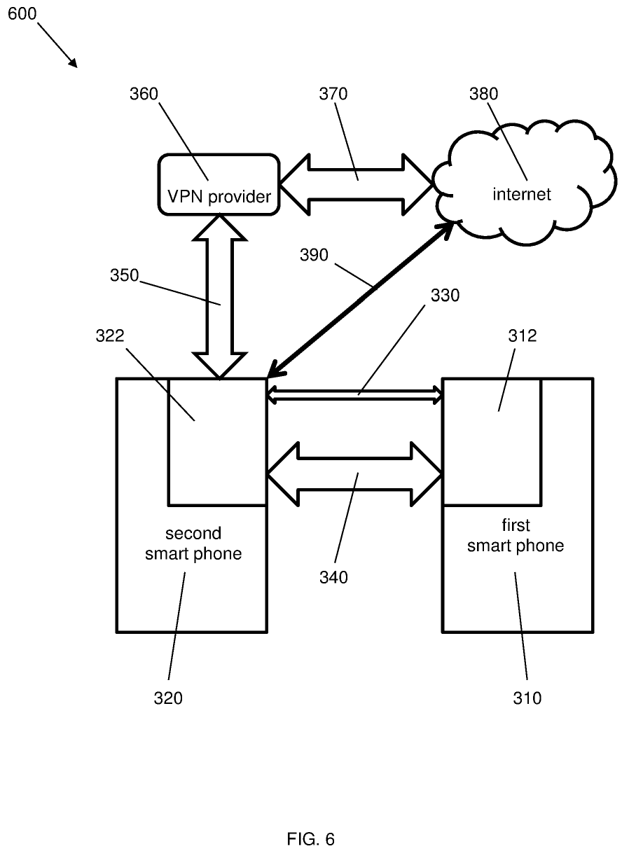

With reference to FIG. 6, there is illustrated a system 600 according to an embodiment of the present invention. In one embodiment, the method 100 of FIG. 1 is performed on the system 600. The system 600 has a first electronic device in the form of a first smart phone 310 and a second electronic device in the form of a second smart phone 320. In this embodiment, the first smart phone 310 wishes to share a connection to the internet 380 (i.e. share data via another electronic device's internet connection) to send an SMS message. This system 600 works in a similar manner to the system 300 of FIG. 3.

The data to be shared (SMS message data) is routed between the first smart phone 310 and an SMS gateway (not shown) connected to the internet 380 via the wireless data connection using the Wi-Fi direct technology signals 340, through the sandbox environment 322 on the second smart phone 320, the secure tunnel 350 to the third party VPN provider 360 and from the third party VPN provider 360 to an SMS gateway (not shown) connected to the internet 380 via the access connection 370. It will be appreciated that if the SMS message data is small enough, the SMS message data can be routed via a wireless data connection using the Bluetooth low energy wireless technology signals 330 in a similar manner to the system 500 of FIG. 5. A benefit of using an SMS gateway is that the second smart phone 320 only requires an internet connection.

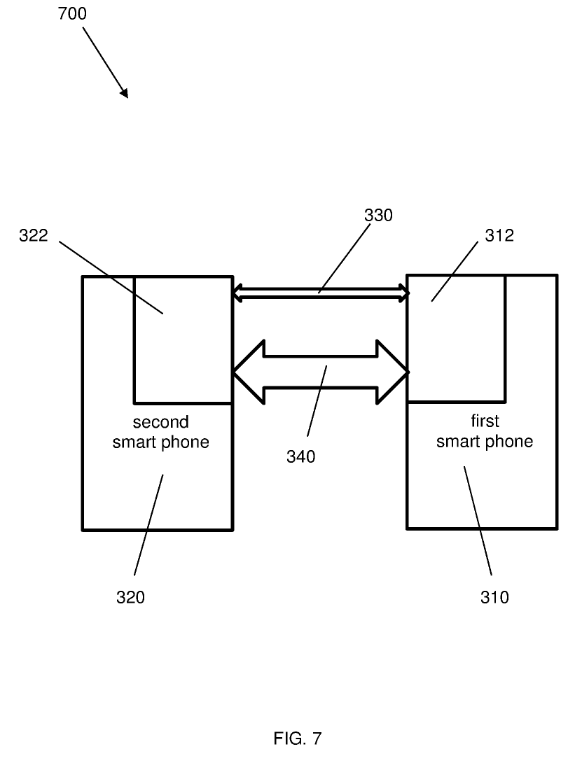

FIG. 7 illustrates a system 700 according to an embodiment of the present invention. In one embodiment, the method 100 of FIG. 1 is performed on the system 700, however, steps 122-128 and 136 are omitted. The system 700 has a first electronic device in the form of a first smart phone 310 and a second electronic device in the form of a second smart phone 320. In this embodiment, the first smart phone 310 wishes to share data that is locally stored on another electronic device.

In a similar manner to the system 300 described with reference to FIG. 3, in the system 700, the first smart phone 310 broadcasts identification data and supplementary data using Bluetooth low energy wireless technology signals 330. The second smart phone 320 receives the identification data and supplementary data and compares the supplementary data to predetermined data and establishes that the first smart phone 310 wishes to share data that is stored on the second smart phone 320 and that the second smart phone 320 is able to share the stored data. For example, the first smart phone 310 may wish to share data relating to golf scores and photos which is stored on the second smart phone 320.

The second smart phone 320 then sends wireless data connection information to the first smart phone 310 using the Bluetooth low energy wireless technology signals 330. The second smart phone 320 then initiates a wireless data connection to the first smart phone 310 using a second wireless technology in the form of Wi-Fi Direct technology signals 340.

Once the wireless data connection using Wi-Fi Direct technology signals 340 is established, the second smart phone 320 sends the data to be shared to the first smart phone 310 via the wireless data connection using Wi-Fi Direct technology signals 340.

In another embodiment (not shown) if the stored data to be shared is small, the second smart phone 320 initiates a wireless data connection to the first smart phone 310 using the Bluetooth low energy wireless technology signals 330 and sends the data to be shared to the first smart phone 310 via the wireless data connection using the Bluetooth low energy wireless technology signals 330. For example, the stored data to be shared may relate to golf scores and can be sent in small packets using the Bluetooth low energy wireless technology signals 330.

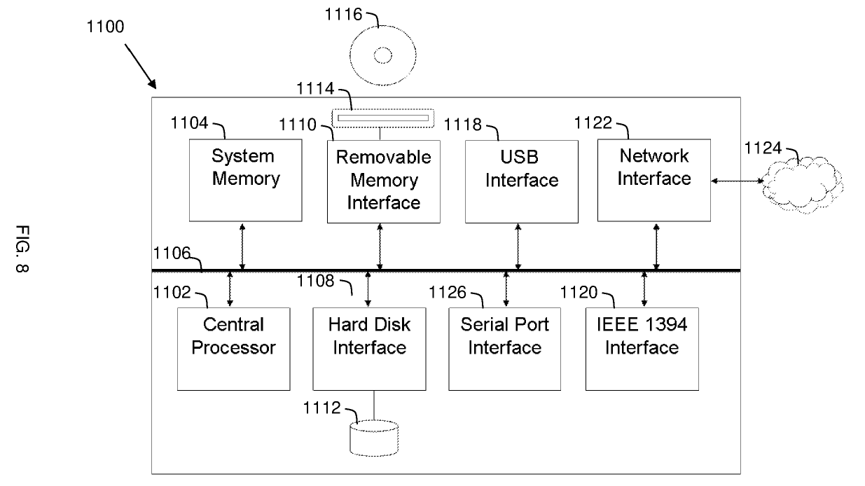

As previously described, the present invention may be implemented using the system 300 of FIG. 3. However it should be appreciated that the present invention may also be performed on an electronic device such as a personal computer, laptop, tablet or smart phone. FIG. 8 diagrammatically illustrates an electronic device 1100 suitable for performing the method of the present invention, such as the first smart phone 310 or the second smart phone 320, according to an embodiment of the present invention. Similarly, the method 100 of FIG. 1 or the method 200 of FIG. 2 can be implemented using the electronic device 1100.

The electronic device 1100 includes a central processor 1102, a system memory 1104 and a system bus 1106 that couples various system components, including coupling the system memory 1104 to the central processor 1102. The system bus 1106 may be any of several types of bus structures including a memory bus or memory controller, a peripheral bus, and a local bus using any of a variety of bus architectures. The structure of system memory 1104 is well known to those skilled in the art and may include a basic input/output system (BIOS) stored in a read only memory (ROM) and one or more program modules such as operating systems, application programs and program data stored in random access memory (RAM).

The electronic device 1100 can also include a variety of interface units and drives for reading and writing data.

In particular, the electronic device 1100 includes a hard disk interface 1108 and a removable memory interface 1110, respectively coupling a hard disk drive 1112 and a removable memory drive 1114 to the system bus 1106. Examples of removable memory drives 1114 include magnetic disk drives and optical disk drives. The drives and their associated computer-readable media, such as a Digital Versatile Disc (DVD) 1116 provide non-volatile storage of computer readable instructions, data structures, program modules and other data for the computer system 1100. A single hard disk drive 1112 and a single removable memory drive 1114 are shown for illustration purposes only and with the understanding that the electronic device 1100 can include several similar drives. Furthermore, the electronic device 1100 can include drives for interfacing with other types of computer readable media.

The electronic device 1100 may include additional interfaces for connecting devices to the system bus 1106. FIG. 12 shows a universal serial bus (USB) interface 1118 which may be used to couple a device to the system bus 1106. For example, an IEEE 1394 interface 1120 may be used to couple additional devices to the electronic device 1100.

The electronic device 1100 can operate in a networked environment using logical connections to one or more remote computers or other devices, such as a server, a router, a network personal computer, a peer device or other common network node, a wireless telephone or wireless personal digital assistant. The electronic device 1100 includes a network interface 1122 that couples the system bus 1106 to a local area network (LAN) 1124. Networking environments are commonplace in offices, enterprise-wide computer networks and home computer systems.

A wide area network (WAN), such as the Internet, can also be accessed by the electronic device 1100, for example via a modem unit connected to a serial port interface 1126 or via the LAN 1124. Transmission of data can be performed using the LAN 1124, the WAN, or a combination thereof.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the electronic device 1100 can be operated in a client-server configuration to permit a user to retrieve data from, for example, a web-based server.

The operation of the electronic device 1100 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants, smart watches, smart wearables and the like. Furthermore, the present invention may also be practiced with other methods of visual output from the computer system, including a virtual reality display, a projection of output into an eye of a user, a projection of output onto a surface within the view of the user, such as eyeglasses or another surface close to the eye. Furthermore, the present invention may also be practiced with other methods of user input to the computer system, including detection of a movement of a limb, a digit, an eye, a head, or a body of a user, detection of a thought by a user, or detection of a mental feature of a user's intention. Furthermore, the invention may also be practiced in distributed computing environments where tasks are performed by remote processing devices that are linked through a communications network. In a distributed computing environment, program modules may be located in both local and remote memory storage devices.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention. For example, individual features from one embodiment may be combined with another embodiment.

1. A method of wireless data sharing between a first electronic device and a second electronic device, including:
broadcasting identification data and supplementary data from the first electronic device using a first wireless technology;
receiving on the second electronic device the identification data and supplementary data;
initiating on the second electronic device an application associated with the identification data;
matching the supplementary data to predetermined data using the application on the second electronic device;
initiating, using the application on the second electronic device, a wireless data connection between the first electronic device and the second electronic device based on the match between the supplementary data and the predetermined data; and
sharing data between the first electronic device and the second electronic device, using the wireless data connection.

2. The method of claim 1, wherein the first wireless technology is a low energy wireless technology.

3. The method of claim 1, wherein the first electronic device is a first mobile electronic device, and the second electronic device is a second mobile electronic device.

4. The method of claim 1, wherein broadcasting identification data and supplementary data from the first electronic device using a first wireless technology includes initiating an application on the first electronic device, the application on the first electronic device initiating the broadcasting of the identification data and supplementary data.

5. The method of claim 1, wherein when the second electronic device receives the identification data and supplementary data, the second electronic device compares the identification data to data relating to the application on the second electronic device and, if there is a match, initiating on the second electronic device an application associated with the identification data is performed.

6. The method of claim 1, further comprising determining at the second electronic device the signal strength of a signal that encodes the broadcast identification data and supplementary data.

7. The method of claim 1, wherein the method includes sending from the second electronic device to the first electronic device information relating to the data to be shared between the first electronic device and the second electronic device.

8. The method of claim 1, wherein the supplementary data relates to a type of data that is to be shared.

9. The method of claim 1, wherein sharing data between the first electronic device and the second electronic device involves sharing an internet connection of the second electronic device with the first electronic device.

10. The method of claim 1, wherein the second electronic device initiates, using the application on the second electronic device, the wireless data connection between the first electronic device and the second electronic device using a second wireless technology.

11. The method of claim 1, wherein initiating, using the application on the second electronic device, a wireless data connection between the first electronic device and the second electronic device based on the match between the supplementary data and the predetermined data further includes sending, using the first wireless technology, from the second electronic device to the first electronic device information relating to the data connection that is to be initiated.

12. The method of claim 1, wherein the application on the second electronic device creates a sandbox environment through which the data to be shared is routed.

13. The method of claim 1, wherein sharing data between the first electronic device and the second electronic device involves sharing a telephone connection of the second electronic device with the first electronic device.

14. The method of claim 1, wherein the application on the second electronic device sends a disconnection warning signal to the first electronic device prior to the wireless data connection between the first electronic device and the second electronic device being disconnected.

15. The method of claim 1, wherein sharing data between the first electronic device and the second electronic device involves sharing a telephone connection of the second electronic device with the first electronic device to facilitate the sending of SMS or MMS messages.

16. The method of claim 1, wherein if the first electronic device sends an SMS message (via the second electronic device), the data connection between the first electronic device and the second electronic device uses the first wireless technology.

17. The method of claim 1, wherein sharing data between the first electronic device and the second electronic device includes sharing the location data of the second electronic device with the first electronic device.

18. The method of claim 1, further including logging an amount of data shared.

19. A system for wireless data sharing between a first electronic device and a second electronic device, the system including the second electronic device having a processor coupled to a memory, the memory including program code instructions configured to cause the processor of the second electronic device to:
receive identification data and supplementary data broadcast by the first electronic device using a first wireless technology;
initiate an application on the second electronic device associated with the identification data;
match the supplementary data to predetermined data;
initiate a wireless data connection between the first electronic device and the second electronic device based on the match between the supplementary data and the predetermined data; and
share data between the first electronic device and the second electronic device.

20. A second electronic device for wireless data sharing between a first electronic device and the second electronic device, the second electronic device including a processor coupled to a memory, the memory including program code instructions configured to cause the processor to:
receive identification data and supplementary data broadcast by the first electronic device using a first wireless technology;
initiate an application on the second electronic device associated with the identification data;
match the supplementary data to predetermined data;
initiate a wireless data connection between the first electronic device and the second electronic device based on the match between the supplementary data and the predetermined data; and
share data between the first electronic device and the second electronic device.
